(19) United States
(12) Patent Application Publication
(10) Pub. No.: US 2011/0291408 A1
(43) Pub. Date: Dec. 1, 2011

(54) Pipe Securing and Sealing System

(75) Inventors: Mark Moldenhauer, Merrill, WI (US); Fred Lane, Mosinee, WI (US)

(73) Assignee: Mark Moldenhauer, Merrill, WI (US)

(21) Appl. No.: 13/116,906

(22) Filed: May 26, 2011

Related U.S. Application Data
(60) Provisional application No. 61/349,546, filed on May 28, 2010.

(51) Int. Cl. F16L 25/00; B23P 17/00

(52) U.S. Cl. 285/330; 29/525.01

(57) ABSTRACT

The present invention relates generally to a sealing system applicable to a ruptured pipe. The invention has application in water main, and oil and gas exploration. It is particularly suited to forming and repairing wellbore casings which may have been damaged in order to alleviate environmental recovery and facilitate oil and gas exploration.

### CROSS REFERENCE TO RELATED APPLICATIONS

This application claims priority from U.S. provisional application No. 61/349,546 filed 28 May 2010; entitled “Pipe Sealing System.” The entire contents being hereby included by reference and for which benefit of the priority date is claimed.

### FIELD OF THE INVENTION

The present invention relates generally to oil and gas exploration and in particular to forming and repairing wellbore casings which may have been damaged to alleviate environmental recovery and facilitate oil and gas exploration.

### BACKGROUND OF THE INVENTION

Conventionally, a wellbore on the ocean floor comprises a section of exposed pipe leading from the ocean floor to an oil rig located on the surface of the ocean.

When a wellbore is ruptured, at or near the surface of the ocean floor, an emergency connection needs to be re-established. Many times the rupture may result in a partial collapse or deformation of the borehole wall creating an uneven surface for attachment and sealing to prevent undesired outflow of drilling fluid into the formation or inflow of fluid from the formation into the borehole.

As a consequence the casing of the upper interval needs to accommodate the inner diameter of the casing of the lower interval. Thus, a connection of the casings can be made in a nested arrangement with casing diameters decreasing in upward direction.

The present invention is directed to overcoming one or more of the limitations of the existing procedures for forming and/or repairing wellbore casings.

### SUMMARY OF THE INVENTION

Therefore it is desired to have an invention such as that outlined in this disclosure comprising a multiple of new features and advantaged not found in the art. Below are listed several of these advantages. This by no means forms a comprehensive list of advantages.

It is an advantage of the present invention to provide a remotely deployable connector between a ruptured lower well casing and a replacement section.

It is a further advantage to provide a self contained assembly which can fit into the inner diameter of the existing ruptured well bore.

It is a further advantage to provide a structure detachable from the wellbore.

It is a further advantage to provide self aligning and self stabilizing structure for attaching a lower well bore to an upper assembly.

It is a further advantage to provide a system where-in the assembly is self sealing.

It is a further advantage to provide a system having a ratcheting holder for reducing the hydraulic holding pressure of the sealing plates.

### BRIEF DESCRIPTION OF THE DRAWINGS

A sufficient understanding of the present invention may be obtained by reference to the accompanying drawings, when considered in conjunction with the subsequent, detailed description, in which:

FIGS. 1 A and B are a perspective view of one embodiment of the present invention having the seal plates retracted;

FIGS. 2 A and B are a perspective view of the embodiment of FIG. 1 having the seal plates extended;

FIGS. 3 A, B, and C are a side view of the embodiment of FIG. 1 having the seal plates retracted;

FIGS. 4 A, B, and C are a side view of the embodiment of FIG. 1 having the seal plates extended;

FIGS. 5A-5E are top, face, bottom, side, and detail views respectively of a groove embodiment of a seal plate;

FIGS. 6A-6E are top, face, bottom, side, and detail views respectively of a tongue embodiment of a seal plate;

FIGS. 7A-7E are top, face, bottom, side, and detail views respectively of a tongue embodiment of a gripping plate;

FIGS. 8A-8E are top, face, bottom, side, and detail views respectively of a groove embodiment of a gripping plate;

FIG. 9A is a sectional view of an alternate embodiment of the present invention prior to engaging an existing pipe;

FIG. 9B is the embodiment of 9A being set upon the existing pipe;

FIG. 9C is the embodiment of 9A being secured to the existing pipe;

FIG. 10 is a sectional view of a third alternate embodiment of the present invention;

FIG. 11 is a sectional view of a fourth alternate embodiment of the present invention;

FIG. 12 is a face view of an alternate embodiment plate after the manner of FIG. 5B.

### DESCRIPTION OF EMBODIMENTS

A listing of elements common across the drawings is given in order to more easily navigate between the Figures. Elements: (20) (34) (124) (134) (144) denote an embodiment of inclined wedge working in cooperation with and engaging a series of plates to form an extendable flange. A first set of plates embodied as: (24) (38) (118) (128) (138). A second set of plates, which is optional and can be extended to some n^{th} value, embodied as: (26) (40) (120) (130) (140). A common characteristic of the plates is that they can generally be interlaced or mated as tongue (46) and groove (44) to form a seal. It is preferred that the tongue (46) and groove (44) be of sufficient depth and dimension so as to not have gaps when in the extended position. It is anticipated that various sealants, putties, coatings and the like can be used to form or enhance fluid tight seal. Further it is anticipated that the arrangement of the plates can vary depending upon whither the embodiment is designed such that the flange is directed outward or inward, such as is shown in FIG. 12.

It is anticipated that a series of collars having embodiments of (22) (36) (116) (126) (136) and corresponding embodiments of (28) (42) (122) (132) (142) can be arranged for holding and aligning the plates, keeping plates in alignment, and to keep them from moving axially along the pipes. Guide pins (37) can also be anchored into the collars and aligned with the races (39) to set the direction and limits to the travel of the plates during use. Retraction springs (not shown) can be embedded into the races to return the plates to a retracted position when not engaged.

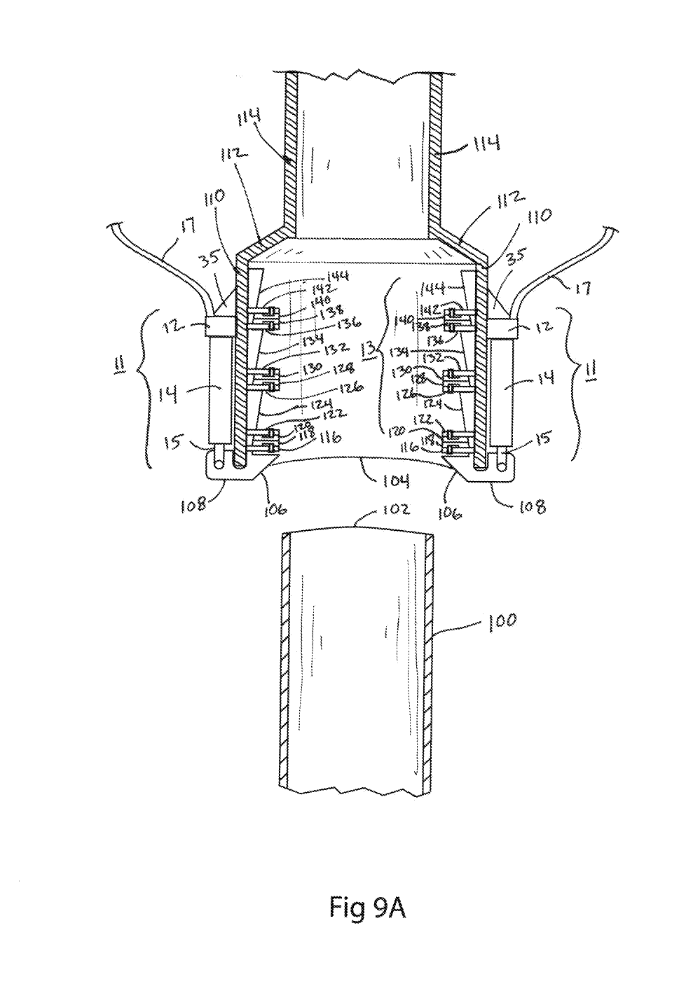

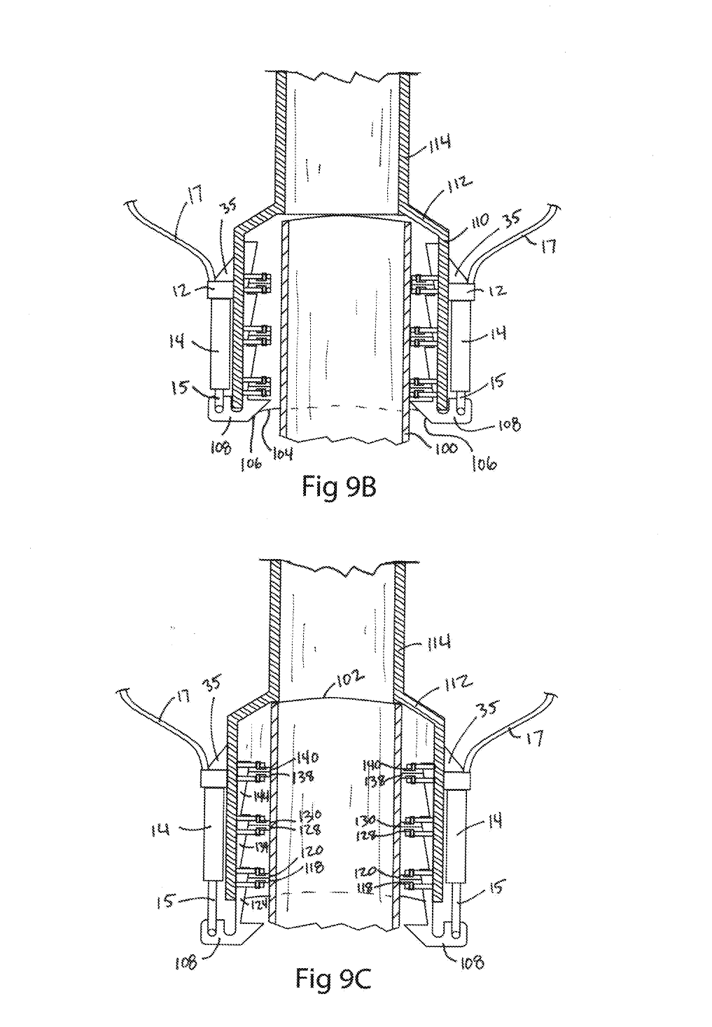

For embodiments where the extendable flange operates inward to attach to the outer surface of the existing pipe (100), see FIGS. 9-11, a shroud shown as elements (110) (210) (310) for covering the existing pipe (100) and provide a surface for mounting hydraulics (14) and flange assemblies as discussed above is provided.

Additionally, a taper shown as elements (112) (212) (312) for interfacing between the respective shroud and connecting pipe (10) is also provided. As will be shown, a taper used in conjunction with an extendable flange can be used to provide a self alignment feature.

The Figures to follow show several embodiments with a generally preferred embodiment of FIG. 9. The present invention being a hydraulic extendable flange (HEF) for conjoining, securing, and substantially sealing an existing section of pipe (100) with a connecting pipe (10) under adverse conditions, such as in situ where traditional work crews and the like cannot gain access. Or traditional joining methods such as welding or bolting flange heads are not practical. Some components of the invention which are not shown yet known to those skilled in the art comprise a section of pipe being an extension of the connecting pipe (10), means for actuating and running hydraulic cylinders such as hydraulic line (17) or pressurized reservoirs to actuate the cylinders (14) and plungers (15), means for directing the HEF into the mating pipe among other things which may vary from embodiment to embodiment within the spirit of this invention, and will be later explained.

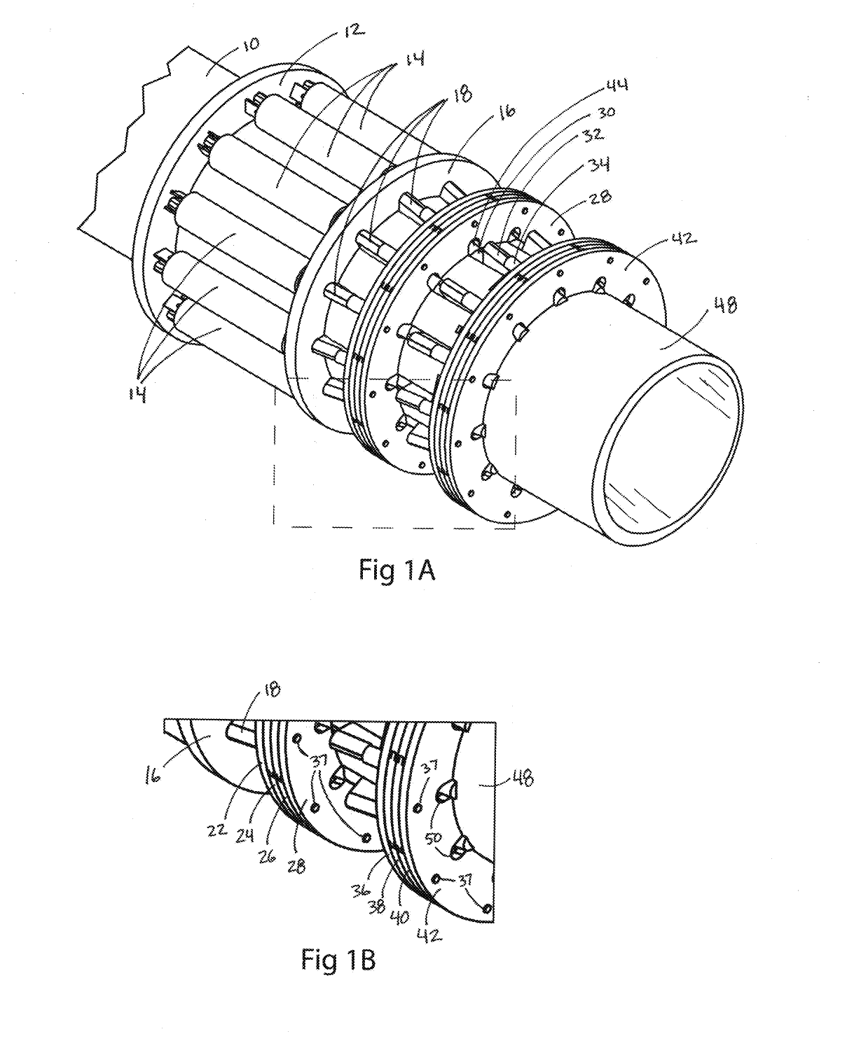

FIGS. 1 through 4 illustrate an overview of one embodiment having a bottom perspective view of the system as could be seen having the distal piping (48) about to enter a mating pipe typically the existing pipe (100) such as a pipe from an oil rig, derrick, or the like and enabled to receive fluid, preferably fossil fuels, and having an anchor point or section such as an anchor flange (12) being securely attached, or even welded, to a surface of the connecting pipe (10) in the case of the embodiment of FIGS. 1-4 the anchor flange (10) and cylinders (14), inclined wedges (18) (20) (32) (34) would be exterior to the connecting pipe (10) and interior to the existing pipe (100) not shown. In the case of FIGS. 9-11, the anchor (12) and the cylinders (14) would be interior for providing an opposing surface for a plurality of piston cylinders (14), preferably hydraulically operated and in a preferred embodiment approximately 12 to 18 in number around the circumference of the piping. Determination of the appropriate number will be function of the diameters of pipe being used, capabilities of the piston cylinders (14) and the system requirements regarding pressures and seals.

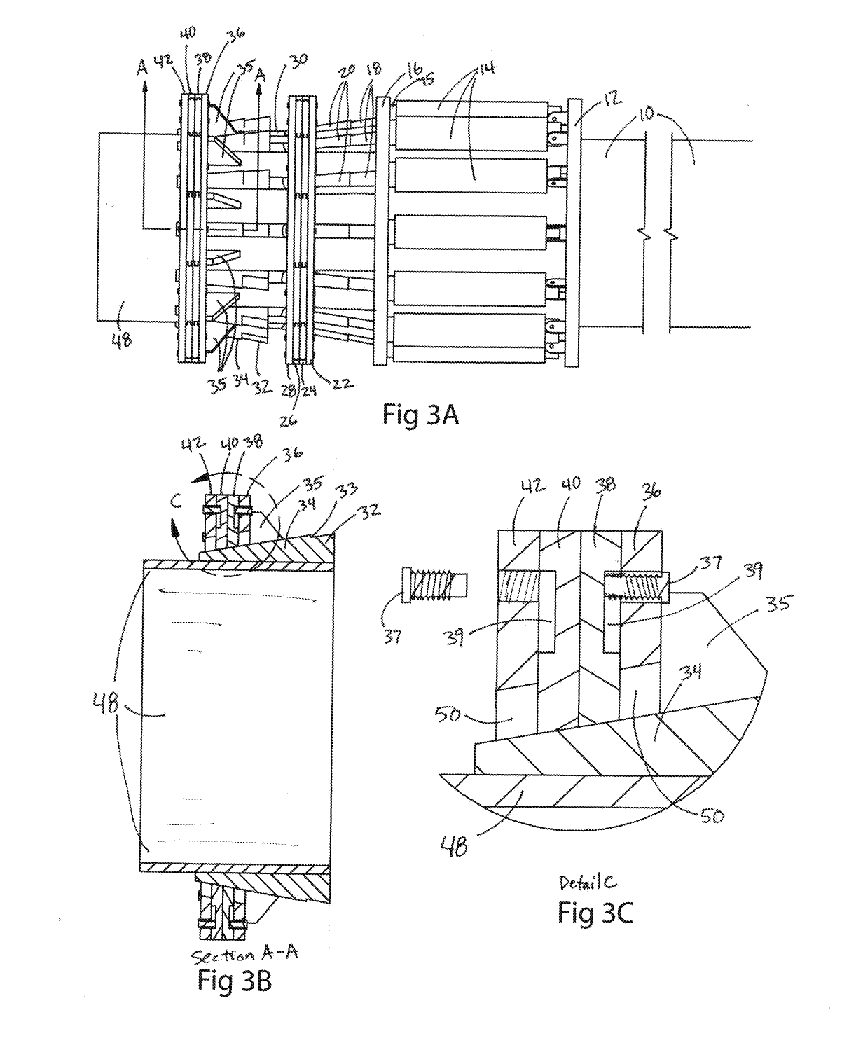

In FIGS. 1 and 3 the HEF is not yet deployed. By way of illustration, FIG. 3C shows The plungers (15) are in retracted position. In retracted position, the wedges (20) (34) set at the tapered portion allowing the plates (38) (40) as shown in FIGS. 3B and 3C to settle substantially flush with the retaining collars (36) (40). The wedges (34) (32) are axially aligned by means of pilot slots (50) provided at regular intervals in the collars (42) (36). The wedges (34) (32) further align with wedge guides (52) in the plates (38) (40) to help keep a registration of the plates around the pipe (10). Guide pins (37), shown here in the form of a hex bolt having an unthreaded end section, are place at regular intervals substantially radially above the pilot slots (50). These guide pins (37) are sized to fit the respective races (39) to guide the plates (38) (40) as they extend outward.

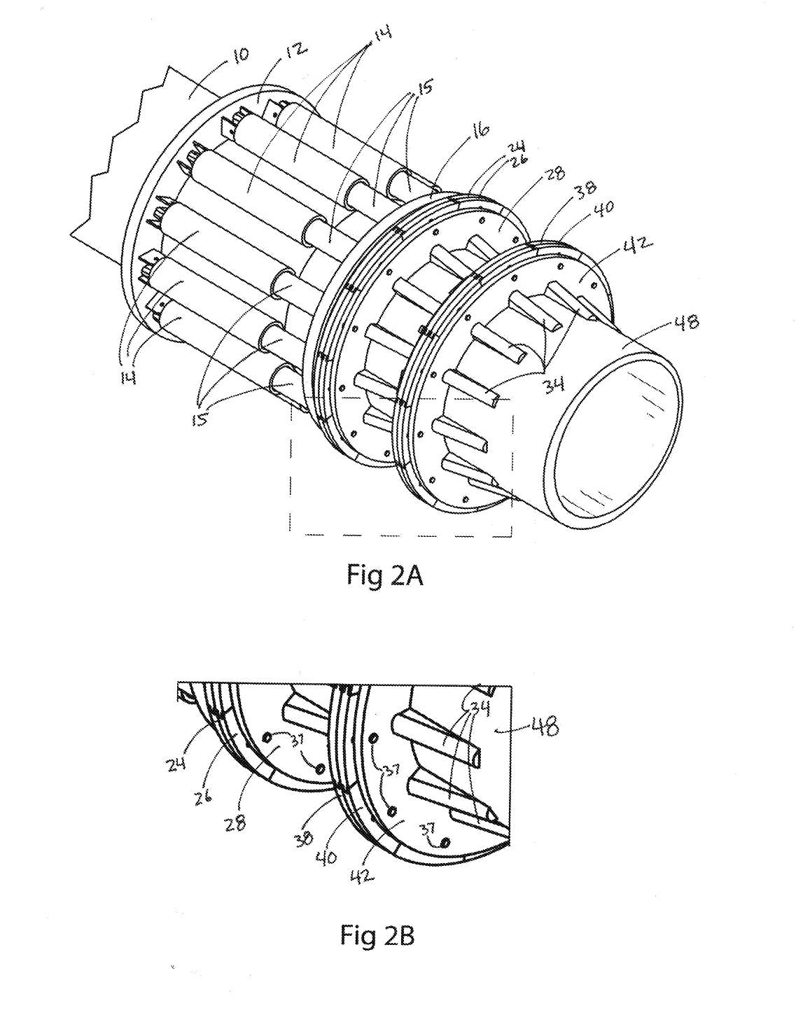

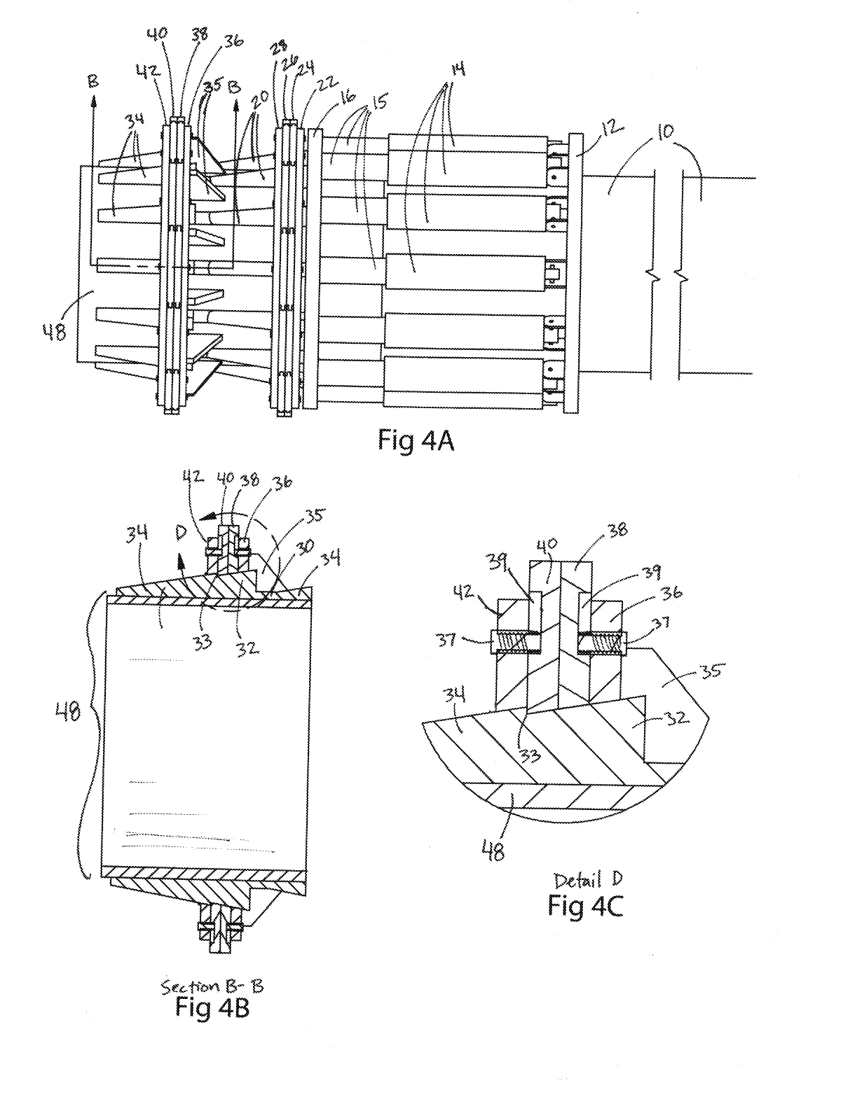

In FIGS. 2 and 4, as the cylinders (14) are actuated the plungers (15) are extended moving an acting flange (16) axially along the pipe (10) toward the distal end (48). In this case the acting flange (16) is useful in tying the force of the plungers (15) to act as one member. The acting flange serves to collect the individual forces applied from each piston to a series of wedges, but one skilled in the art can appreciate that the acting flange can be removed or modified to allow each wedge to be moved independently, or quasi-independently allowing the plates to self align or accommodate to irregularities which may be present in the mating pipe surface. The present embodiment is provided for illustration. As the flange (16) moves axially toward the distal end (48), the wedges (18) (20) (32) (34) slide from thin to thicker dimensions, pushing the plates (24) (26) (38) (40) move along the guide pins (37) extending them above the collars (22) (28) (36) (42) this creating an effectively larger diameter flange which interfaces to engage with the inside diameter of the pipe (100) to secure and seal the two together.

In an alternate embodiment, the wedges may further comprise an incline wedge portion (20) (34) and at least one latching wedge portion (18) (32) to reduce or eliminate back pressure onto the piston, (in this case hydraulic) once the HEF is deployed and the system is in place. The latch point (33) between the two portions is best seen in FIG. 4C and is provided to lock or latch the plates (38) (40), in this case, to provide security that a hydraulic leak would not impact the system over time. In yet another embodiment (not shown) a similar ratchet, brace, or latch may be deployed on the plunger once it is fully extended to keep it from relaxing.

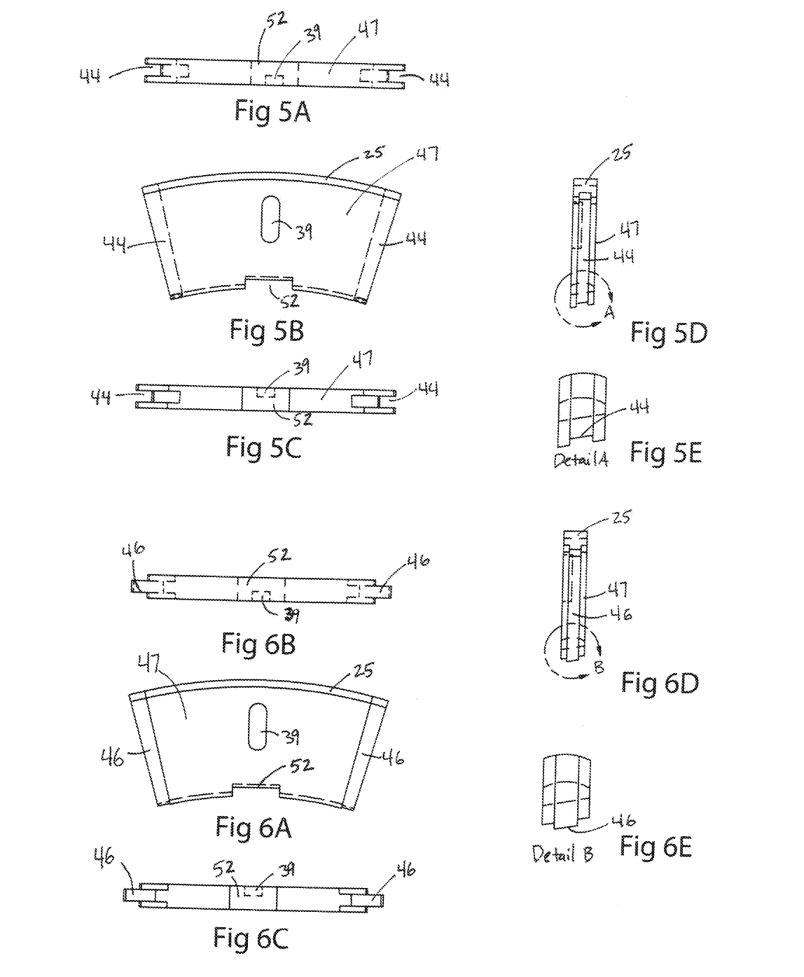

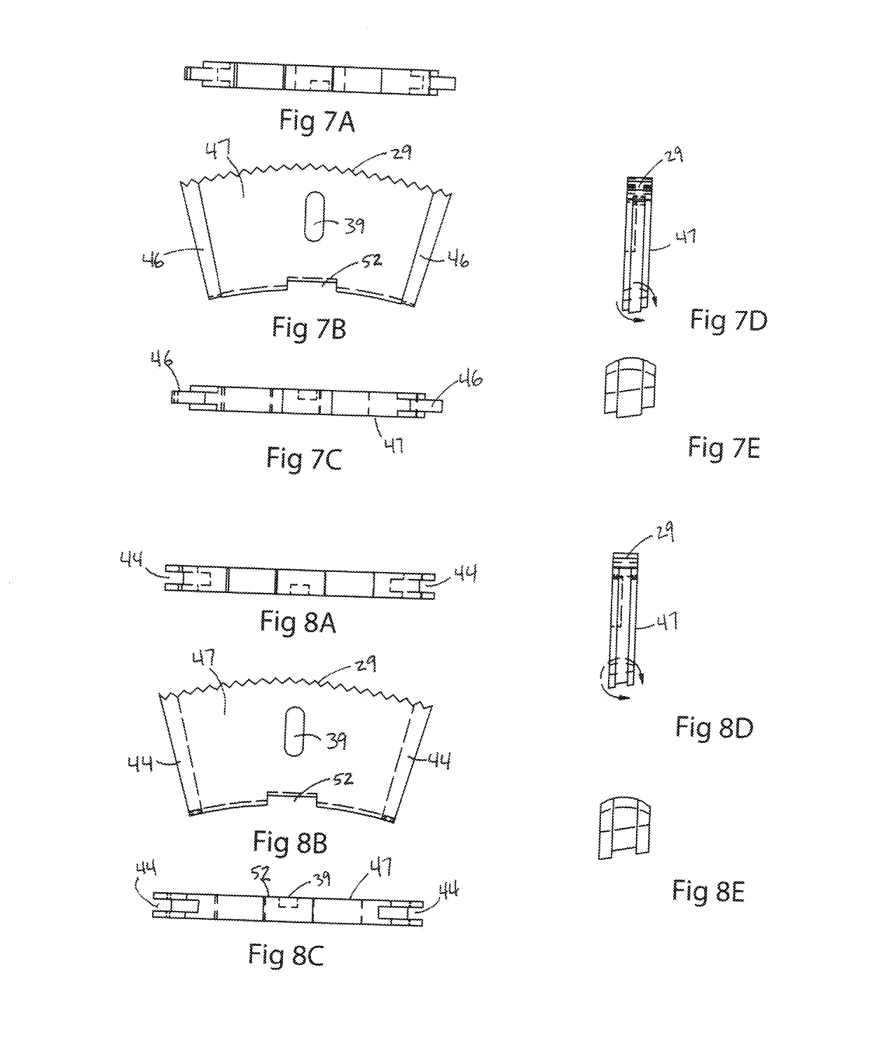

As seen in FIGS. 5-8, the plates can comprise a sealing surface (25) or a gripping surface (29) as required by the user. The sealing surface can be selected from a conformal or compressible material. Selection should be designed to allow sufficient material to form a seal, yet not so much as to compromise the structural integrity. Further, the number, placement, and pressures, etc. can be specified and provides a system of redundant or distributed seals. It is also seen that the design of the wedges can combine some combination of tongue (46) and groove (44) to overlap the seals.

As the wedges move down the pipe, each first inclined wedge is directed toward and through a matching pilot slot located on one or more series of retaining collars which are securely attached to the pipe. The wedges may be designed to provide an approximately 8:1 to 10:1 leverage factor, allowing for smaller, lower profile hydraulics.

One skilled in the art will appreciate that although one series of retaining collars comprising a first proximal and a first distal retaining collar may be sufficient to form a seal, the second proximal retaining collar and the second distal retaining collar are provided to increase the stability of the HEF system from lateral rotation in addition to providing more material and points of sealing. One can also see the value of having a system that is scalable or expandable such that the addition of supplementary retaining collars beyond 2 can provide for better gripping and sealing. Further, each collar can be designed to provide differing levels of radial force as needed to optimize attachment and seal.

In a family of alternative embodiments shown in FIGS. 9-11, a system is provided whereby the HEF is situated on the outside of the existing pipe (100) instead of the inside. A manner of operation for this system is shown in FIG. 9. A drive mechanism (11) is securely attached to a surface of a connecting pipe (10) and more particularly a shroud (110). The drive mechanism comprising at least one and preferably a plurality of; hydraulic supplies (17), connected with a corresponding piston cylinder (14), the piston cylinder being attached by means of an anchor (12) to the shroud (110). A coupler (108) transfers motion of the plunger (15) to the drive mechanism (13). The coupler (108) can further comprise a guide chamfer (106) which serves to protect the first retaining collar (116) and help guide the pipe (100) into the shroud (110). The drive mechanism (13) comprises at least one HEF as explained above.

The shroud (110) is lowered over the existing pipe (100) substantially until the existing pipe abuts with the top of the taper (112). The taper (112) being sloped so as to guide the pipe (110) into position. One should not be concerned that the two pipes do not align exactly, for example in FIG. 9B shows the pipe (100) skewed to the right inside the shroud (110). As the drive mechanism (11) is activated, at least one of the set of plates (118) (120) (128) (130) (140) (138) extend to form a holding and sealing interface in a self aligning way. The existing pipe (100) is centered and held fast at the top of the taper (112) such that the fluid flows directly into the connecting pipe (114) with no interruption or constriction.

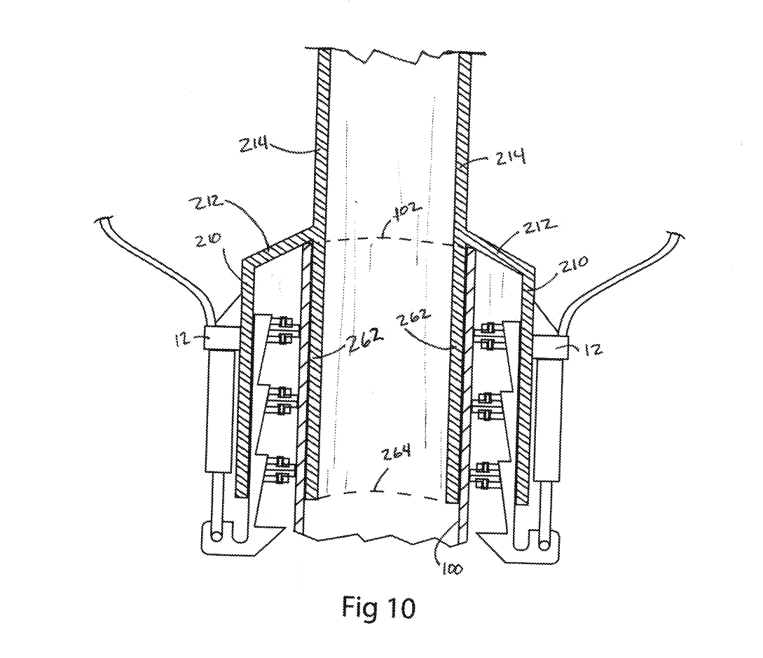

FIG. 10 shows an alternate embodiment having a sleeve (262) which extends to a terminating point (264) which may or may not coincide with the length of the shroud (210). Some advantages for using a sleeve (262) could be to reinforce the existing pipe (100) from crushing, to extend the interface region, or to provide further lateral stabilization.

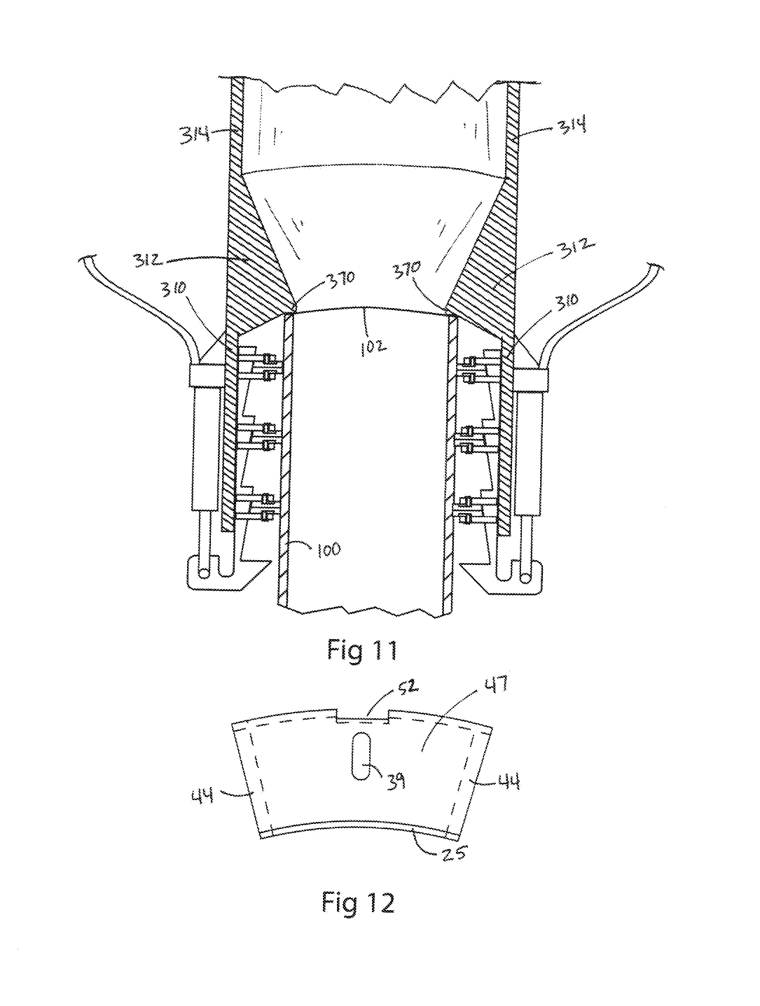

FIG. 11 shows another alternate embodiment wherein an expansion taper (312) is formed between the shroud (310) and the connecting pipe (314) being aligned at an interface (370). Advantages for such an expansion would be to further expand the fluid, reduce line pressures, or mate pipes of different diameters.

When designing with an inwardly extending flange (HEF), a modification is required to the plate. FIG. 12 shows a face (47) of an inwardly extending plate having the plate guide (52) on the outer portion and, in this case, the sealing edge (25) directed inwardly. As one skilled in the art would readily recognize, when designing under this embodiment, one should take care that the sizes and the dimensions of the tongue and groove (44) do not bind or impinge as the plates move inwardly together.

### CONCLUSION, RAMIFICATIONS, AND SCOPE

Although the present invention has been described in detail, those skilled in the art will understand that various changes, substitutions, and alterations herein may be made without departing from the spirit and scope of the invention in its broadest form. The invention is not considered limited to the example chosen for purposes of disclosure, and covers all changes and modifications which do not constitute departures from the true spirit and scope of this invention.

Having thus described the invention, what is desired to be protected by Letters Patent is presented in the subsequent appended claims.

What is claimed is:

1. A method for joining a connecting pipe to an existing pipe comprising:
i. providing a driving mechanism being securely attached to a surface of the connecting pipe;
ii. connecting the driving mechanism with a series of wedges, the wedges being slidably held by at least one pair of retaining collars;
iii. providing a plurality of plates also being oriented and held in connection with the retaining collar, the plates being operatively connected with the wedges;
iv. overlapping the connecting pipe with the existing pipe to a predetermined distance;
v. actuating the driving mechanism such that the wedges working in cooperation with the plurality of plates results in the plates being forced toward the existing section of pipe.

2. The method for joining a connecting pipe to an existing pipe in accordance with claim 1 wherein the driving mechanism further comprises a hydraulic driver.

3. The method for joining a connecting pipe to an existing pipe in accordance with claim 2 further comprising the series of plates being associated by means of tongue and groove to seal the spaces between the plates.

4. The method for joining a connecting pipe to an existing pipe in accordance with claim 2 further comprising; the series of plates having at least one race and the pair of retaining collars having at least one guide pin for controlling the direction of travel of the respective plate.

5. The method for joining a connecting pipe to an existing pipe in accordance with claim 3 further comprising; at least one of a sealing edge and a gripping edge.

6. The method for joining a connecting pipe to an existing pipe in accordance with claim 5 further comprising multiple pairs of retaining collars with corresponding plates for redundancy.

7. The method for joining a connecting pipe to an existing pipe in accordance with claim 6 wherein at least one wedge comprises a ratcheting detent.

8. The method for joining a connecting pipe to an existing pipe in accordance with claim 7 wherein the minimum distance of the predetermined distance comprises having all the plates of the connecting pipe overlap the existing pipe.

9. The method for joining a connecting pipe to an existing pipe in accordance with claim 8 wherein the connecting pipe inserts into the existing pipe.

10. The method for joining a connecting pipe to an existing pipe in accordance with claim 8 wherein the connecting pipe shrouds the existing pipe.

11. The method for joining a connecting pipe to an existing pipe in accordance with claim 10 wherein the connecting pipe further comprises an aligning feature for providing centering and depth stop points between the connecting pipe and the existing pipe.

12. The method for joining a connecting pipe to an existing pipe in accordance with claim 11 wherein the connecting pipe performs the function of; matching, expanding, or constricting the flow of the existing pipe.

13. The method for joining a connecting pipe to an existing pipe in accordance with claim 12 wherein a multiple of wedges are driven for each hydraulic.

14. A connector assembly for joining an in situ pipe with a connecting pipe comprising:
i. a hydraulic drive mechanism being securely attached to the surface of the connecting pipe;
ii. the drive mechanism attached to a series of wedges, the wedges being slidably held by at least one pair of retaining collars situated at predetermined locations on the connecting pipe;
iii. a series of plates being joined together by means of tongue and groove and oriented and held by the at least one pair of retaining collars;
iv. operably connecting the wedges and series of plates such that when the driving mechanism is actuated, the plates are forced toward the in situ pipe.

15. The connector assembly for joining an in situ pipe with a connecting pipe in accordance with claim 14 further comprising at least one wedge in the series of wedges having a ratcheting detent.

16. The connector assembly for joining an in situ pipe with a connecting pipe in accordance with claim 14 wherein the connecting pipe is fitted inside the in situ pipe.

17. The connector assembly for joining an in situ pipe with a connecting pipe in accordance with claim 14 wherein the connecting pipe enshrouds the in situ pipe.

18. The connector assembly for joining an in situ pipe with a connecting pipe in accordance with claim 17 wherein the connecting pipe is self aligning with the in situ pipe.

19. The connector assembly for joining an in situ pipe with a connecting pipe in accordance with claim 18 wherein the connecting pipe can be matched with the in situ pipe to provide one of a matching, expanding, or constricting of the flow of the in situ pipe.

20. A method for joining a connecting pipe to an existing pipe comprising:
i. providing a hydraulic driving mechanism being axially aligned with and securely attached to a distal surface of the connecting pipe;
ii. connecting the driving mechanism with a series of wedges, the wedges having a ratcheting detent for holding the wedges in place after being driven in place; the wedges being slidably held by at least one pair of retaining collars;
iii. providing a plurality of plates also being connected and substantially forming a ring by means of a tongue and groove assembly, and bing oriented and held in connection with the retaining collar, the plates being operatively connected with the wedges;
iv. overlapping the connecting pipe with the existing pipe to a predetermined distance and in such a way that the connecting pipe concentrically aligns with the existing pipe;
v. actuating the driving mechanism such that the wedges working in cooperation with the plurality of plates results in the plates are forced toward the existing section of pipe forming a fluid tight seal.
